(19) United States
(12) Patent Application Publication
(10) Pub. No.: US 2026/0370662 A1
(43) Pub. Date: Nov. 19, 2026

(54) Intelligent Application Programming Interface (API) Discovery

(71) Applicant: Zscaler, Inc., San Jose, CA (US)

(72) Inventors: Jane Joseph, Leander, TX (US); Christopher Malladi, Boston, MA (US); Pankaj Kumar, Columbus, OH (US); Pankaj Kumar, Bangalore (IN); Shyam Pullela, San Jose, CA (US)

(73) Assignee: Zscaler, Inc., San Jose, CA (US)

(21) Appl. No.: 19/251,504

(22) Filed: Jun. 26, 2025

(30) Foreign Application Priority Data
May 14, 2025 (IN) 202541046280

(51) Int. Cl. H04L 9/40; G06F 9/54

(52) U.S. Cl. CPC H04L 63/1416; G06F 9/547; H04L 63/1425; H04L 63/1433

(57) ABSTRACT

Systems and methods for intelligent API detection include monitoring a tenant's cloud environment to detect and analyze Application Programming Interface (API) traffic, wherein the monitoring includes inspecting network communication to identify API endpoints and user interactions associated with the API endpoints; identifying one or more API endpoints from the monitored traffic, including active APIs, inactive APIs, shadow APIs, and zombie APIs, and extracting metadata associated with the API endpoints; detecting suspicious activity associated with an identified API endpoint, including analyzing user access patterns, identifying repeated access attempts to zombie APIs, or determining sensitive data exposure caused by API transactions; and generating an alert for the tenant associated with the API endpoint and the detected suspicious activity, the alert containing information about the API endpoint, a user or client responsible for the detected suspicious activity, and risks associated therewith.

### FIELD OF THE DISCLOSURE

The present disclosure generally relates to network and cloud security. More particularly, the present disclosure relates to systems and methods for intelligent API discovery.

### BACKGROUND OF THE DISCLOSURE

In today's digital landscape, Application Programming Interfaces (APIs) serve as the backbone of modern applications, enabling seamless integration, data exchange, and automation across diverse platforms. APIs drive innovation by connecting systems, services, and users. However, this rapid growth of API ecosystems has also introduced significant challenges. Organizations often struggle to maintain visibility into their API inventories, making it difficult to track which APIs are deployed, how they are being used, and by whom. Furthermore, outdated, undocumented, or forgotten APIs, commonly referred to as shadow and zombie APIs, pose security and compliance risks, as they can become exploitable entry points for attackers. Unauthorized access, data breaches involving sensitive information, and API misuse are increasingly common, underscoring the need for robust tools to address these vulnerabilities. Traditional API management solutions provide some level of visibility and security, but they are often limited to basic traffic monitoring, threat detection, or compliance checks, failing to offer a comprehensive view of both API and user behaviors. Recognizing this gap, the present invention introduces an intelligent system capable of both API and user discovery, enhanced security controls, and granular analytics.

### BRIEF SUMMARY OF THE DISCLOSURE

The present disclosure relates to systems and methods for intelligent API discovery. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring a tenant's cloud environment to detect and analyze Application Programming Interface (API) traffic, wherein the monitoring includes inspecting network communication to identify API endpoints and user interactions associated with the API endpoints; identifying one or more API endpoints from the monitored traffic, including active APIs, inactive APIs, shadow APIs, and zombie APIs, and extracting metadata associated with the API endpoints; detecting suspicious activity associated with an identified API endpoint, including analyzing user access patterns, identifying repeated access attempts to zombie APIs, or determining sensitive data exposure caused by API transactions; and generating an alert for the tenant associated with the API endpoint and the detected suspicious activity, the alert containing information about the API endpoint, a user or client responsible for the detected suspicious activity, and risks associated therewith.

The steps can further include automatically blocking a flagged user or client from accessing the identified API endpoint based on the detected suspicious activity. The monitoring can include leveraging an Artificial Intelligence (AI)/Machine Learning (ML) pipeline to analyze API traffic patterns and perform Natural Language Processing (NLP) on API schemas to identify unique API endpoints. Analyzing user access patterns can include determining metrics such as first access, last access, request frequency, and response codes for each API endpoint accessed by a user. The alert generated can include contextual data regarding the API endpoint, prior user interactions, security vulnerabilities, and associated risks, enabling the tenant to take further actions. The steps can include categorizing APIs as active, inactive, shadow APIs, or zombie APIs based on traffic inspection and metadata analysis. Detecting suspicious activity can include identifying sensitive data exposed through API transactions and associating exposures with specific users and API endpoints. Detecting suspicious activity can include identifying repeated unauthorized access attempts to an API endpoint. The steps can include dynamically updating API endpoint inventories for the tenant whenever new APIs are detected or existing APIs are decommissioned. The steps can include scoring API endpoints based on their associated security risk levels, wherein the scoring considers factors including the frequency of suspicious activity, sensitive data exposure, and API configuration vulnerabilities.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram of an intelligent API discovery system architecture.

FIG. 6 is a flowchart of a process for intelligent API discovery.

### DETAILED DESCRIPTION OF THE DISCLOSURE

Again, the present disclosure relates to systems and methods for intelligent API discovery. This invention introduces an intelligent system for comprehensive API discovery, user behavior analytics, and advanced security controls, designed to address the critical challenges of managing modern API ecosystems. The system dynamically discovers and catalogs all API endpoints, including shadow and zombie APIs, across an organization's environment. It provides detailed insights into API-specific information, such as usage statistics, authentication methods, exposed Hypertext Transfer Protocol (HTTP) methods, and traffic patterns, as well as user-specific behavior, including access patterns, violations, and sensitive data exposure. The system also integrates seamlessly with existing workflows and employs scalable cloud-native infrastructure to ensure efficiency and extensibility. Its focus on granular analytics, real-time visibility, and proactive security measures allows organizations to detect vulnerabilities, prevent misuse, optimize API usage, and secure sensitive data, enabling a smarter and safer API ecosystem.

### § 1.0 Cybersecurity Monitoring and Protection Examples

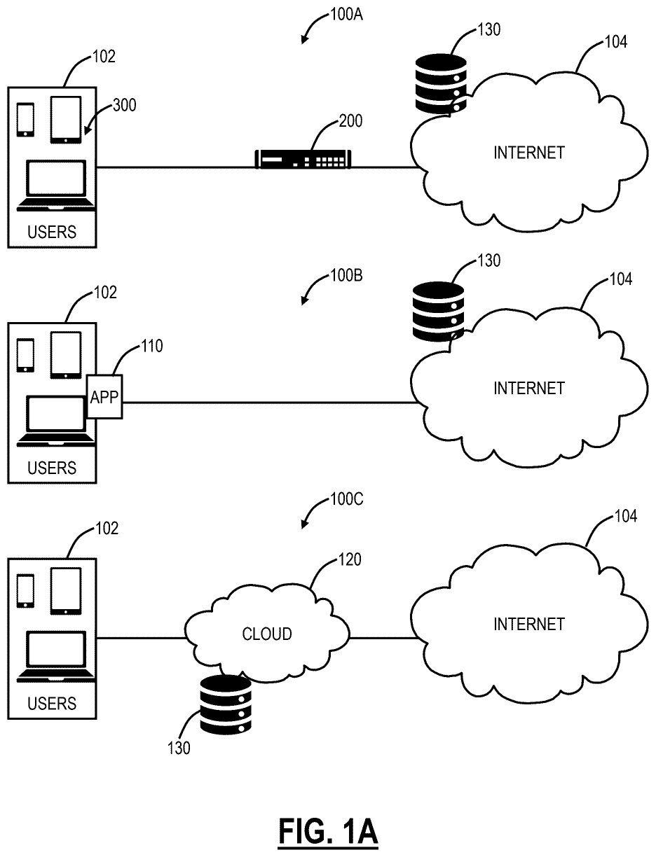

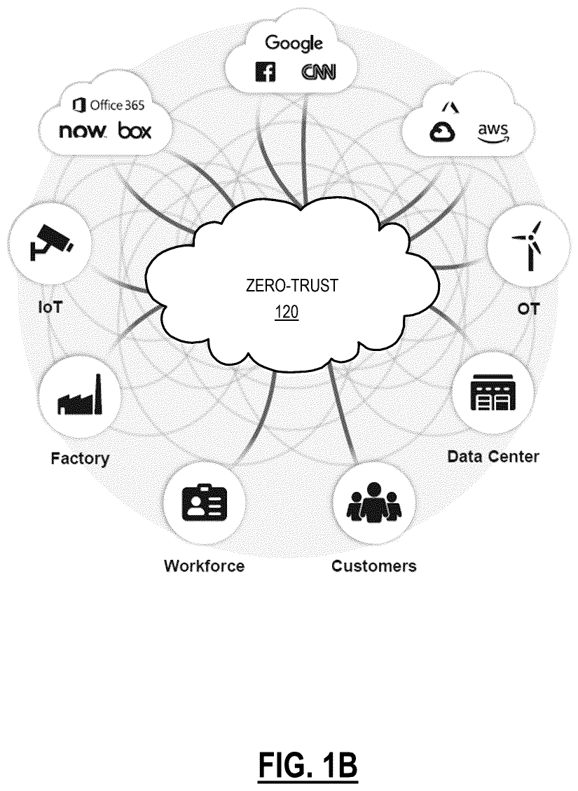

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

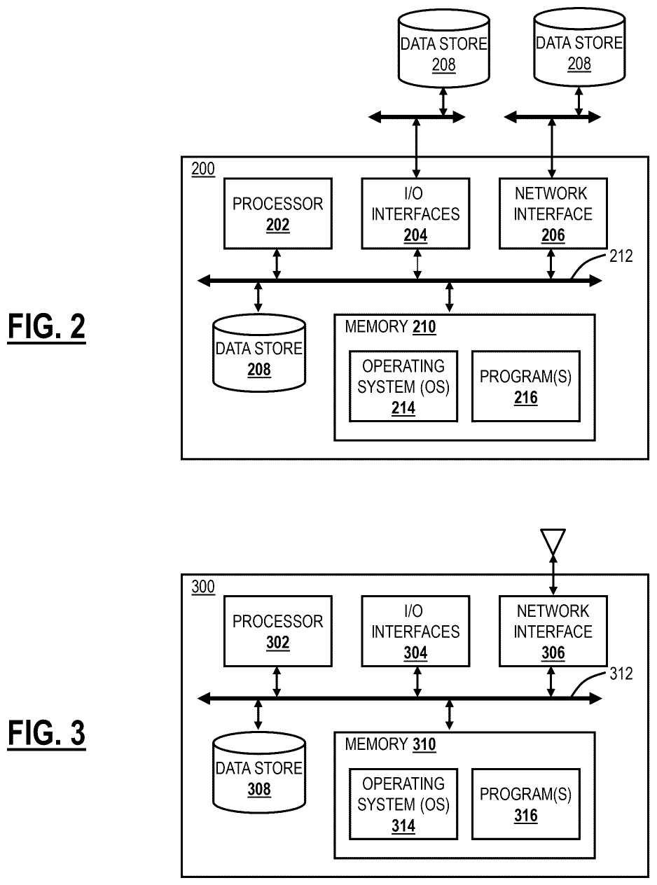

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

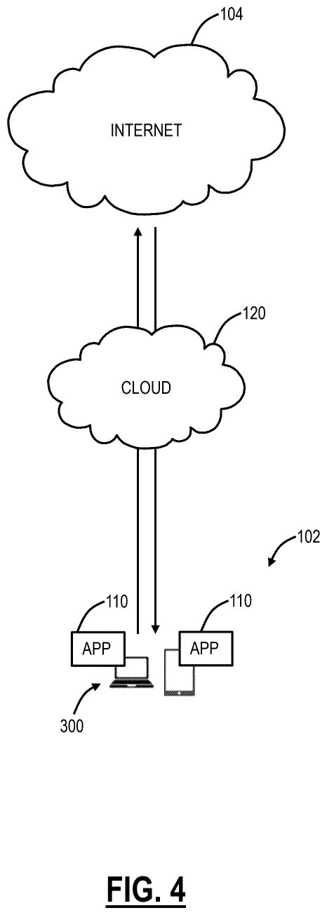

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Intelligent API Discovery

APIs play an indispensable role across diverse sectors such as banking, retail, transportation, IoT (Internet of Things), autonomous vehicles, and smart cities. Serving as the backbone of modern mobile, Software-as-a-Service (SaaS), and web applications, APIs seamlessly integrate functionalities and data exchange across customer-facing, partner-facing, and internal applications. However, the very essence of APIs, their ability to expose application logic and sensitive data like Personally Identifiable Information (PII), has made them a lucrative target for cyber attackers.

In response to these security challenges, the present invention introduces an intelligent API discovery and protection system. This advanced approach enables organizations to automatically identify, catalog, and establish an inventory of all their APIs, whether these APIs are internally developed, adopted from third-party services, or actively engaged in use. By analyzing API traffic and operations, this system provides comprehensive visibility into an organization's API ecosystem. Most importantly, it integrates sophisticated security measures to safeguard these APIs from unauthorized access, misuse, or malicious attacks. In essence, this invention not only locates and categorizes an organization's APIs but also ensures they are fortified against evolving threats, enabling enterprises to innovate securely and efficiently. This dual capability of discovery and protection fundamentally transforms how organizations manage and secure their digital assets, paving the way for sustained technological progress.

The process of effectively managing an organization's APIs begins with the critical function of identifying and cataloging all APIs. This includes not only internal or private APIs but also undocumented shadow APIs, forgotten or deprecated zombie APIs, and any APIs that are currently unsupported or outdated. The system can further encompass public APIs and third-party APIs integrated within an organization's environment. The focus of this function is on intelligently detecting and tracking the unique schemas of API endpoints, providing a detailed overview of various aspects related to hosted APIs.

The method employed for this task involves advanced traffic inspection and log analysis, powered by automated and intelligent pipelines of the cloud 120. These pipelines meticulously examine traffic patterns to identify distinct API endpoint structures and derive their associated schemas. This comprehensive approach ensures that the system not only discovers APIs but also tracks their evolution over time. Alongside endpoint discovery, it generates valuable insights into each API, including details on its schema, functionalities, inherent vulnerabilities, and usage statistics. This iterative process ensures that organizations maintain an up-to-date summary of all API endpoints while uncovering critical elements such as undocumented APIs, security gaps, and usage trends.

The benefits of such a system are multifaceted. By gaining a complete and comprehensive understanding of their API ecosystem, organizations can efficiently manage API usage while proactively addressing potential security vulnerabilities. The insights provided enable key functionalities such as achieving full API visibility, identifying API types in use (such as Representational State Transfer (REST), Simple Object Access Protocol (SOAP), Graph Query Language (GraphQL), etc.), and understanding authentication mechanisms (e.g., Basic Auth, Token-based, Open Authorization (OAuth), API Key, Cookie, Open ID Connect (OIDC)). Additionally, organizations can track the flow of sensitive data to identify any vulnerabilities related to PII, access keys, or other critical data, while also detecting shadow and zombie APIs. Furthermore, this system allows for targeted enhancements to an organization's overall security profile by evaluating high-risk domains and securing APIs against potential threats. By ensuring comprehensive API visibility and protection, this approach equips organizations with the tools they need to innovate securely while mitigating risks in an increasingly interconnected and API-reliant digital landscape.

In the rapidly evolving landscape of API discovery, numerous solutions are available, but the majority are primarily centered around threat detection or analyzing API behaviors to ensure compliance with standards such as Payment Card Industry (PCI) regulations. These traditional approaches tend to focus on monitoring traffic patterns to detect anomalies or assess security risks. While effective in their specific domains, such solutions often lack the depth needed for a more granular understanding of APIs and their users.

What sets the present API discovery system apart is its innovative use of advanced Artificial Intelligence (AI)/Machine Learning (ML) pipelines, which go beyond conventional traffic analysis. Unlike traditional methods, the present system delves deeper into understanding the fundamental elements of APIs. It not only identifies APIs themselves but also extends its capabilities to provide comprehensive API user discovery. This includes tracing individual API transactions, offering unprecedented visibility into how APIs are accessed, used, or potentially misused.

By leveraging AI and ML, the present systems can intelligently derive insights into API behavior and relationships in ways that are otherwise challenging to achieve with static or rule-based systems. The result is a dynamic, scalable, and more insightful solution that not only promotes operational efficiency but also strengthens overall security by providing context-rich visibility into API usage across an organization. This elevated approach empowers organizations to address emerging security threats, optimize API utilization, and innovate with confidence in the face of increasing complexity in API ecosystems.

Again, this invention introduces an intelligent pipeline designed to streamline API discovery by generating detailed API endpoint schemas along with a wealth of actionable insights. Using a feedback-driven approach to API discovery, the system ensures that once an API endpoint is identified, it remains consistently recognized within the inventory, regardless of changes or updates. Underpinning this pipeline is a robust AI/ML clustering algorithm that utilizes Natural Language Processing (NLP) for API endpoint analysis. Based on predefined grammar rules and configurable threshold settings, the pipeline dynamically derives schemas to accurately map API structures and functionalities, enabling organizations to gain precise visibility into their API ecosystem.

Operating offline, the pipeline leverages cluster infrastructure to run on a scheduler and continually discover new APIs and insights with exceptional efficiency and confidence. By harnessing the power of such clusters, the pipeline ensures scalability, reliability, and optimal utilization of resources, making it capable of handling large-scale and complex API environments with ease. Furthermore, the architecture is designed with integration in mind, offering seamless compatibility with Continuous Integration and Continuous Deployment (CI/CD) pipelines to ensure modern development workflows benefit from automated API discovery and security analysis. The added emphasis on delivering a high-quality user experience ensures that organizations can leverage this solution intuitively, reducing onboarding time and enhancing operational efficiency.

The infrastructure of the pipeline is purposefully built to be flexible and extendable. This design allows it to integrate easily not only with third-party platforms but also across the suite of Zscaler products, including Zscaler Client Connector (ZCC), i.e., the agent application, Zscaler Internet Access (ZIA), Zscaler Developer Kit (ZDK), and Zscaler Digital Experience (ZDX). Again, the Zscaler cloud is an example cloud 120, and the present systems can be implemented in any cloud-based system of the like. This extensibility ensures that the invention is adaptable to evolving needs and can work across different environments while maintaining a cohesive and robust API discovery process. Ultimately, this pipeline represents a cutting-edge innovation that combines machine learning, natural language processing, and scalable cloud-native technologies to deliver unparalleled API insights, driving both operational efficiency and platform security in today's interconnected digital landscape.

### § 5.1 Intelligent API Discovery Architecture

This disclosure outlines the architecture and design approach for implementing intelligent API discovery and security enhancements, while also accommodating provisions for future refinements and scalability. The proposed solution focuses on addressing critical requirements at a high level, which include intelligent API endpoint discovery and analytics, enhanced API activity visibility and insights, advanced API security controls, and an optimized user experience for API protection. These pillars aim to redefine how organizations manage, monitor, and secure their API ecosystems, ensuring a robust framework that promotes operational security and efficiency.

Among the key use cases and insights derived from API discovery and API user discovery through comprehensive log analytics are several powerful functionalities. First and foremost, the system facilitates the discovery of all APIs present within a customer's network, including REST APIs, GraphQL APIs, SOAP APIs, etc. This broad-spectrum approach ensures that organizations attain complete visibility into their API landscape. Additionally, the solution offers insights into all users accessing APIs, detailing when users accessed specific endpoints and how many times those interactions occurred. This level of granular detail empowers organizations to analyze usage patterns and detect anomalies.

Another significant capability lies in identifying API traffic that may have exposed sensitive user information, such as PII or access keys, enabling organizations to preemptively address vulnerabilities. The system provides API traffic visibility and statistical insights, such as distinguishing between active, inactive, and newly discovered APIs. For example, an inactive API is classified as one that has not been accessed in the past 30 days (customizable by default), whereas a newly discovered API is identified as one detected for the first time within the last 30 days. These classifications allow organizations to efficiently manage their APIs by identifying redundancy, optimizing resources, or improving monitoring of new endpoints.

Moreover, the system enables organizations to retrieve insightful metrics, such as the most or least accessed API endpoints, users interacting with the least frequently accessed endpoints, or the top users by API activity volume. These insights offer transparency into usage trends and empower data-driven decisions, such as identifying gaps or inefficiencies in API designs. Expanding on its security capabilities, the solution is designed to detect high-risk APIs, as well as uncover and classify zombie APIs (deprecated or forgotten APIs) and shadow APIs (undocumented APIs outside the organization's standard framework). It also pinpoints users with the highest number of security violations, enabling proactive remediation and strengthening compliance adherence.

By delivering comprehensive insights such as identifying APIs of highest risk, traffic flow patterns, and user behaviors, this architecture and design represent a cutting-edge approach to API management. The system not only improves operational visibility and security but also serves as an intelligent tool for discovering and assessing API behaviors with precision. As a result, this solution empowers organizations to confidently innovate while maintaining a secure and well-managed API ecosystem.

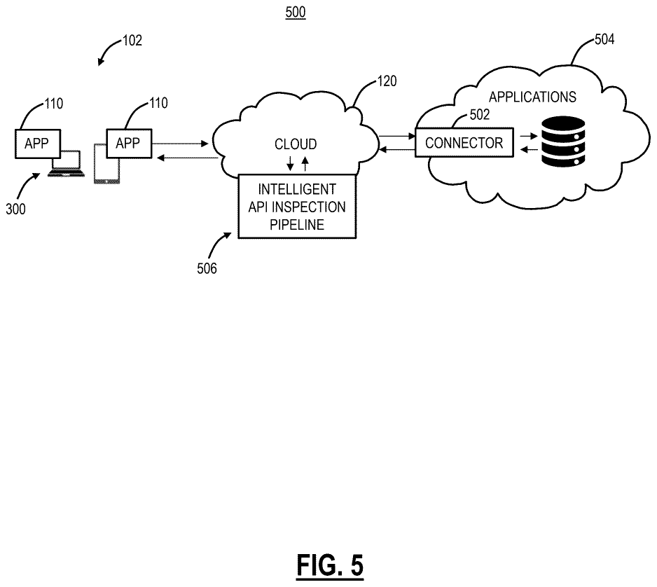

FIG. 5 is a diagram of an intelligent API discovery system architecture 500. The end-to-end workflow of an API inspection log is a multi-step, meticulously orchestrated process that enables organizations to leverage advanced analytics, enforce API security policies, and facilitate intelligent API discovery. The workflow begins with the configuration of the application domain using Web Application Firewall (WAF), HTTP inspection, or auto-inspection mechanisms. At this initial stage, “Wally,” or other configuration manager, downloads the inspection controls and profile tables from a Relational Database (RDB). The configuration manager then updates a broker and application connector of the cloud 120 with any configuration changes to ensure that the latest settings are seamlessly propagated across the system.

When an agent application 110 or Browser Access (BA) client on an endpoint connects to the cloud broker of the cloud 120, it evaluates the access and inspection policies, along with the associated profile for the requested application of the tenants applications 504. These policies and profiles guide how traffic will be handled for the specific application under inspection. The client sends a zpn_broker_request to initiate the interaction. Once the application connector 502 establishes a connection with the data broker, it retrieves the inspection application and profile configuration from the configuration manager and consumes these configurations for pipeline inspection. At this point, the connector 502 terminates the traffic and identifies the underlying protocol using the Protocol Detection Processing (PDP) library. This enables the traffic to be routed to the appropriate inspection pipeline based on its type.

Within the inspection pipeline 506, several key operations take place. First, the system determines whether the traffic constitutes API activity. If identified as API traffic, it extracts relevant metadata for API analytics, enabling visibility into API activities and patterns. The inspection profile is then applied, which enforces API controls and evaluates the traffic for potential attack signatures. Depending on the threat level and the configured policies, actions such as issuing alerts or outright blocking malicious traffic are executed. Additionally, the WAF inspection labels specific API logs for inclusion in the API discovery process, ensuring that these logs contribute to the ongoing tracking and inventorying of APIs.

The connector 502 serializes the WAF inspection logs, embedding relevant API inspection data, and sends them to the control broker. From there, the logs are further streamed to designated producers located in the tenant's respective logging zones. Within these zones, producers process the logs, identify the appropriate Kafka topic for WAF inspection logs, and stream them to the Kafka server.

Once the data reaches Kafka, multiple processing layers are triggered. For instance, the elastic search ingester and druid ingester services process these logs to support advanced diagnostics and facilitate a drill-down service within the admin User Interface (UI), retaining the processed data for up to 14 days, or any other configured period. Meanwhile, the S3 ML ingester service operates per logging zone and supports integration with platforms designed for deeper analytics. These analytics include data discovery, threat hunting, anomaly detection, user risk score generation, and more.

An essential component of the process is the intelligent API discovery pipeline 506, which operates an NLP-driven AI/ML method to identify unique API endpoints using URI pattern recognition. This pipeline 506 dynamically derives the API endpoint schema while also generating detailed statistics for API discovery, visibility, and visualization. The pipeline 506 is scheduled and managed by the job manager, a Java application integrated with a job scheduling library. This scheduling framework supports flexible configurations, enabling tasks to run at specific times, intervals, or in line with complex triggers, including cron-like expressions. The scheduler acts as the central component that governs the execution of all jobs and triggers to ensure smooth operations.

Through this comprehensive workflow, the system delivers real-time API traffic visibility, detects vulnerabilities, enforces security controls, and facilitates groundbreaking API discovery and analytics. By employing robust scheduling, scalable orchestration, and intelligent algorithms, this architecture forms the backbone of a modern, well-secured, and highly visible API management system tailored for dynamic enterprise environments.

The present systems and methods are designed to discover, analyze, and display two key categories of API-related information. This includes API-specific information and user-specific information. These capabilities allow organizations to gain detailed insights into both the APIs operating within their environments and the behaviors of users interacting with those APIs. By providing visibility into these two crucial dimensions, the system empowers customers to better manage their API ecosystems, enhance security, and detect potential vulnerabilities or anomalies.

For user-specific information, the system uncovers and provides comprehensive details about users accessing a customer's API endpoints. This includes tracking which domains and specific API endpoints a particular user attempts to access, as well as maintaining a timeline of the user's interactions. Details such as the first time the user accessed an API endpoint, their most recent access, and the total number of times they have accessed each endpoint are recorded. Additionally, the system identifies any violations that occurred during their access, such as attempts to bypass security controls or trigger unauthorized API calls. The system also captures and analyzes response error codes associated with user interactions, providing granular insights into failed requests, such as instances of invalid permissions or resource unavailability. These capabilities not only reveal potential misuse or abnormal behaviors but also aid in ongoing monitoring and compliance reporting.

Similarly, the system offers detailed API-specific insights for each domain or API endpoint in a customer's environment. For every discovered API endpoint, the system logs when the endpoint was first detected (“first time seen”) and the last time it was active or accessed (“last time seen”). The total number of requests made to each endpoint is also recorded, providing a clear view of its usage and popularity. Furthermore, the system captures critical technical details, including the types of authentication methods observed for the endpoint (e.g., Basic Auth, OAuth, API Key), and the classification of the API itself (e.g., REST API, SOAP API, or other protocol types). It also identifies the different HTTP methods exposed by the endpoint (e.g., GET, READ, PUT, POST) and tracks how frequently each method is invoked by users.

Beyond technical and usage dimensions, the system dives deeper into API security and compliance insights. It identifies the client types of users attempting to interact with the API endpoint (e.g., mobile apps, browsers, third-party scripts) and flags any security violations detected during these interactions. Another significant feature is the ability to pinpoint specific sensitive information (e.g., Personally Identifiable Information (PII) or access credentials) that may have been exposed through API transactions. For each API endpoint, the system provides a record of specific transactions that facilitated the leakage of sensitive information, along with the details of what was exposed, and which users were responsible for these transactions. This feature not only assists in identifying and mitigating risks but also aids in incident response and data protection efforts.

By systematically uncovering and organizing both user-specific and API-specific data, the system provides a holistic perspective on API usage and security. It allows organizations to closely monitor user behaviors, understand endpoint-specific trends, identify vulnerabilities, and implement more targeted security measures. Whether it involves tracking unexpected exposure of sensitive data, monitoring access patterns, or analyzing API usage at a granular level, the system offers the insights necessary to safeguard and optimize API operations in dynamic and evolving environments.

### § 5.2 Intelligent Api Discovery Use Case

An embodiment of the intelligent API discovery system operates within a cloud-based environment to provide tenant-specific visibility into API endpoints and the users interacting with them. Designed for multi-tenant cloud architectures, such as the cloud 120, the system ensures that each tenant has a secure and isolated view of their API ecosystem while enabling the discovery, cataloging, and analysis of API activity unique to their environment. The system begins by leveraging advanced AI/ML-powered pipelines to inspect network traffic, HTTP headers, payloads, and other relevant data streams, identifying all API endpoints deployed within a tenant's environment. This includes not only traditional APIs, such as REST, SOAP, and GraphQL, but also undocumented Shadow APIs and deprecated Zombie APIs that may remain active. For each discovered endpoint, the system extracts detailed metadata, including its URI, the type of API (e.g., REST or SOAP), authentication methods used (e.g., OAuth, API Keys), HTTP methods exposed (e.g., GET, POST, PUT), and its frequency and volume of access. These comprehensive insights allow tenants to better understand their API usage patterns and ensure effective management.

In addition to API endpoint discovery, the system provides granular visibility into the users interacting with those endpoints. It tracks critical behavioral data, such as the domains or endpoints accessed by a user, the timeline of access (e.g., first access, previous access, and most recent access), and how frequently a user interacts with each endpoint. The system also identifies and flags policy violations, such as unauthorized access attempts, and analyzes error responses encountered by users (e.g., HTTP 401/403 codes), helping to pinpoint anomalies or potential risks. By combining endpoint-specific and user-specific data, tenants gain a holistic view of how their APIs are being used and how they may be exposed to security risks or compliance concerns.

Traffic inspection is central to this embodiment, with the system monitoring large-scale tenant-specific traffic flows to extract actionable insights. Using intelligent log analysis pipelines, the system processes API traffic to detect patterns, classify transactions, and compile data specific to each tenant's environment. API endpoint metadata and user behavior data are then organized into actionable dashboards and reports for the tenants. These reports include a variety of metrics, such as the number of requests made to each API endpoint, authentication methods employed, HTTP methods invoked, sensitive information exposed during transactions, and aggregated patterns of user interactions. The system also categorizes APIs as active, inactive (e.g., not accessed for 30 days), or newly discovered (e.g., detected for the first time in recent traffic), enabling tenants to optimize their API management efforts.

Employing feedback-driven machine learning, the system dynamically adjusts to evolving API schemas and traffic patterns, enabling real-time discovery and classification of newly introduced endpoints. This ensures the system continually learns and improves its accuracy with every analysis cycle. Furthermore, the system integrates seamlessly with CI/CD pipelines, allowing tenants to leverage its insights during API development and deployment stages, effectively mitigating operational risks. By flagging high-risk APIs, such as those exposing sensitive information, and identifying malicious users displaying suspicious behaviors, the system enhances tenants'security profiles and helps prioritize remediation efforts.

This embodiment delivers immense value to organizations operating in a shared cloud-based infrastructure by empowering them with detailed, tenant-specific insights into API endpoint behaviors and user interactions. By facilitating real-time discovery, comprehensive analytics, and proactive security detection, the system enables tenants to streamline API management, fortify endpoint security, and maintain compliance with regulatory policies. Its dynamic learning capabilities and scalable architecture ensure operational efficiency and adaptability as tenants expand their API ecosystems or introduce new endpoints over time.

A practical example use case that highlights the capabilities of the intelligent API discovery system is when a user is detected attempting to access a zombie API multiple times. Zombie APIs refer to deprecated or outdated APIs that are no longer actively maintained but remain exposed within a tenant's environment. These APIs can pose significant security risks, as they may lack updates, documentation, or proper controls, making them potential entry points for exploitation. This scenario exemplifies how the system can identify suspicious activity, alert the tenant, and proactively secure the exposed API against further unauthorized access.

The workflow begins when the intelligent API discovery system detects repeated access attempts to a zombie API by a particular user. Using its traffic inspection capabilities, the system monitors real-time API activity and discovers patterns of behavior indicating abnormal API usage. For instance, the user may make multiple repeated requests to the deprecated API endpoint within a short period or systematically probe the API using different HTTP methods (such as POST, PUT, or DELETE) to explore weaknesses in its functionality. These attempts could be indicative of malicious intent, such as trying to exploit outdated vulnerabilities, or could simply result from misconfigured automation scripts or applications tied to the tenant's network.

Once suspicious behavior is identified, the system flags this activity and generates an alert for the tenant's security administrators. The alert contains detailed information about the user, including their identity (e.g., username or client identifier), the frequency and number of access attempts, the specific zombie API being targeted, and any associated HTTP response codes. Additionally, the system evaluates the context of the activity, analyzing whether the requests are bypassing authentication mechanisms, triggering errors, or possibly exposing sensitive data during transactions. The alert serves to inform the tenant of the anomaly and enables them to take manual corrective actions, such as reviewing configurations or investigating the user's intent.

More importantly, the system is equipped with automated defense capabilities to mitigate risks in real time. Once unauthorized access attempts to the zombie API are detected, the system preemptively enforces security policies to protect the API and the tenant environment. Leveraging its policy framework, the system can automatically block the user from accessing the specific zombie API endpoint without disrupting the tenant's broader operations. This dynamic blocking action is implemented by the application connector, which terminates the suspicious traffic at the API endpoint level, preventing further interactions from the flagged user.

Furthermore, the system logs all relevant details of the incident, including timestamps, user actions, attempted HTTP methods, and any error codes generated, which can be forwarded to external logging and security systems, such as Security Information and Event Management (SIEM) platforms. These logs create a trail for audit purposes, allowing the tenant to conduct a comprehensive investigation into the user's motivations and ensure that the security gaps associated with the zombie API are addressed, such as removing or fully decommissioning the outdated endpoint.

This use case highlights the system's ability to integrate proactive security measures with intelligent discovery. By identifying unusual access patterns to risky API endpoints, providing immediate alerts to the tenant, and automatically applying blocking mechanisms, the system safeguards tenants from potential exploitation. It enables organizations to mitigate risks associated with outdated APIs while maintaining visibility and control over both their API ecosystem and user interactions.

### § 5.2 Intelligent API Discovery Process

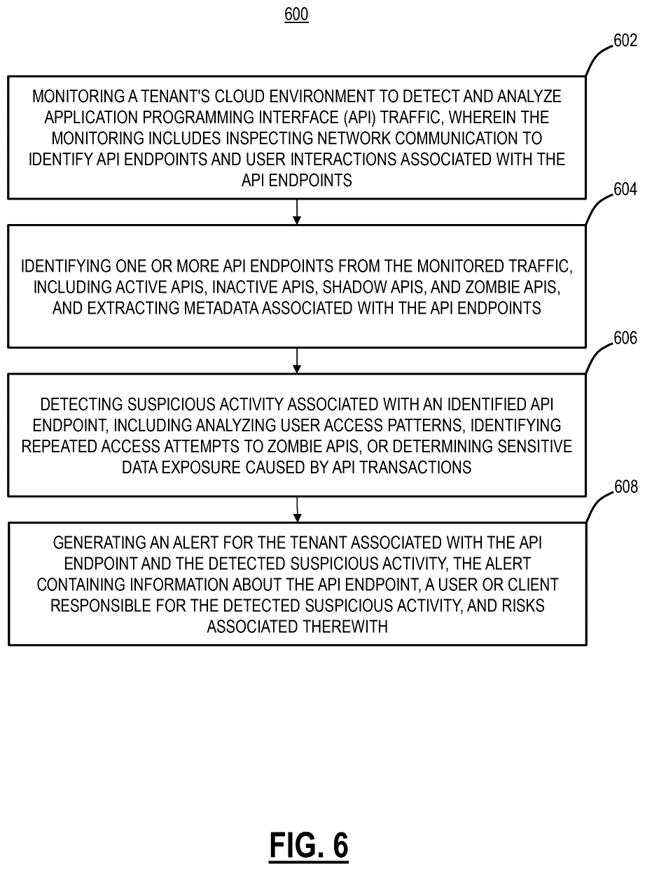

FIG. 6 is a flowchart of a process for intelligent API discovery. In various embodiments, the process 600 includes a method having steps, a processing device configured to implement the steps, a cloud-based system configured to implement the steps, and as a non-transitory computer-readable medium storing instructions for programming one or more processors to execute the steps. The steps include monitoring a tenant's cloud environment to detect and analyze Application Programming Interface (API) traffic, wherein the monitoring includes inspecting network communication to identify API endpoints and user interactions associated with the API endpoints (step 602); identifying one or more API endpoints from the monitored traffic, including active APIs, inactive APIs, shadow APIs, and zombie APIs, and extracting metadata associated with the API endpoints (step 604); detecting suspicious activity associated with an identified API endpoint, including analyzing user access patterns, identifying repeated access attempts to zombie APIs, or determining sensitive data exposure caused by API transactions (step 606); and generating an alert for the tenant associated with the API endpoint and the detected suspicious activity, the alert containing information about the API endpoint, a user or client responsible for the detected suspicious activity, and risks associated therewith (step 608).

The process 600 can further include automatically blocking a flagged user or client from accessing the identified API endpoint based on the detected suspicious activity. The monitoring can include leveraging an Artificial Intelligence (AI)/Machine Learning (ML) pipeline to analyze API traffic patterns and perform Natural Language Processing (NLP) on API schemas to identify unique API endpoints. Analyzing user access patterns can include determining metrics such as first access, last access, request frequency, and response codes for each API endpoint accessed by a user. The alert generated can include contextual data regarding the API endpoint, prior user interactions, security vulnerabilities, and associated risks, enabling the tenant to take further actions. The steps can include categorizing APIs as active, inactive, shadow APIs, or zombie APIs based on traffic inspection and metadata analysis. Detecting suspicious activity can include identifying sensitive data exposed through API transactions and associating exposures with specific users and API endpoints. Detecting suspicious activity can include identifying repeated unauthorized access attempts to an API endpoint. The steps can include dynamically updating API endpoint inventories for the tenant whenever new APIs are detected or existing APIs are decommissioned. The steps can include scoring API endpoints based on their associated security risk levels, wherein the scoring considers factors including the frequency of suspicious activity, sensitive data exposure, and API configuration vulnerabilities.

### § 6.0 Processing Circuitry and Non-transitory Computer-readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
monitoring a tenant's cloud environment to detect and analyze Application Programming Interface (API) traffic, wherein the monitoring includes inspecting network communication to identify API endpoints and user interactions associated with the API endpoints;
identifying one or more API endpoints from the monitored traffic, including active APIs, inactive APIs, shadow APIs, and zombie APIs, and extracting metadata associated with the API endpoints;
detecting suspicious activity associated with an identified API endpoint, including analyzing user access patterns, identifying repeated access attempts to zombie APIs, or determining sensitive data exposure caused by API transactions; and
generating an alert for the tenant associated with the API endpoint and the detected suspicious activity, the alert containing information about the API endpoint, a user or client responsible for the detected suspicious activity, and risks associated therewith.

2. The method of claim 1, further comprising automatically blocking a flagged user or client from accessing the identified API endpoint based on the detected suspicious activity.

3. The method of claim 1, wherein the monitoring includes leveraging an Artificial Intelligence (AI)/Machine Learning (ML) pipeline to analyze API traffic patterns and perform Natural Language Processing (NLP) on API schemas to identify unique API endpoints.

4. The method of claim 1, wherein analyzing user access patterns includes determining metrics such as first access, last access, request frequency, and response codes for each API endpoint accessed by a user.

5. The method of claim 1, wherein the alert generated includes contextual data regarding the API endpoint, prior user interactions, security vulnerabilities, and associated risks, enabling the tenant to take further actions.

6. The method of claim 1, further comprising categorizing APIs as active, inactive, shadow APIs, or zombie APIs based on traffic inspection and metadata analysis.

7. The method of claim 1, wherein detecting suspicious activity includes identifying sensitive data exposed through API transactions and associating exposures with specific users and API endpoints.

8. The method of claim 1, wherein detecting suspicious activity includes identifying repeated unauthorized access attempts to an API endpoint.

9. The method of claim 1, further comprising dynamically updating API endpoint inventories for the tenant whenever new APIs are detected or existing APIs are decommissioned.

10. The method of claim 1, further comprising scoring API endpoints based on their associated security risk levels, wherein the scoring considers factors including a frequency of suspicious activity, sensitive data exposure, and API configuration vulnerabilities.

11. A non-transitory computer-readable medium comprising instructions that, when executed, cause one or more processors to perform steps of:
monitoring a tenant's cloud environment to detect and analyze Application Programming Interface (API) traffic, wherein the monitoring includes inspecting network communication to identify API endpoints and user interactions associated with the API endpoints;
identifying one or more API endpoints from the monitored traffic, including active APIs, inactive APIs, shadow APIs, and zombie APIs, and extracting metadata associated with the API endpoints;
detecting suspicious activity associated with an identified API endpoint, including analyzing user access patterns, identifying repeated access attempts to zombie APIs, or determining sensitive data exposure caused by API transactions; and
generating an alert for the tenant associated with the API endpoint and the detected suspicious activity, the alert containing information about the API endpoint, a user or client responsible for the detected suspicious activity, and risks associated therewith.

12. The non-transitory computer-readable medium of claim 11, further comprising automatically blocking a flagged user or client from accessing the identified API endpoint based on the detected suspicious activity.

13. The non-transitory computer-readable medium of claim 11, wherein the monitoring includes leveraging an Artificial Intelligence (AI)/Machine Learning (ML) pipeline to analyze API traffic patterns and perform Natural Language Processing (NLP) on API schemas to identify unique API endpoints.

14. The non-transitory computer-readable medium of claim 11, wherein analyzing user access patterns includes determining metrics such as first access, last access, request frequency, and response codes for each API endpoint accessed by a user.

15. The non-transitory computer-readable medium of claim 11, wherein the alert generated includes contextual data regarding the API endpoint, prior user interactions, security vulnerabilities, and associated risks, enabling the tenant to take further actions.

16. The non-transitory computer-readable medium of claim 11, further comprising categorizing APIs as active, inactive, shadow APIs, or zombie APIs based on traffic inspection and metadata analysis.

17. The non-transitory computer-readable medium of claim 11, wherein detecting suspicious activity includes identifying sensitive data exposed through API transactions and associating exposures with specific users and API endpoints.

18. The non-transitory computer-readable medium of claim 11, wherein detecting suspicious activity includes identifying repeated unauthorized access attempts to an API endpoint.

19. The non-transitory computer-readable medium of claim 11, further comprising dynamically updating API endpoint inventories for the tenant whenever new APIs are detected or existing APIs are decommissioned.

20. The non-transitory computer-readable medium of claim 11, further comprising scoring API endpoints based on their associated security risk levels, wherein the scoring considers factors including a frequency of suspicious activity, sensitive data exposure, and API configuration vulnerabilities.
